(19) United States
(12) Patent Application Publication
(10) Pub. No.: US 2007/0243508 A1
(43) Pub. Date: Oct. 18, 2007

(54) Diabetic teaching process

(76) Inventor: Floyd A. Fitzjarrald JR., Irvine, CA (US)

Correspondence Address: Floyd A. Fitzjarrald JR., 41 Ashbrook, Irvine, CA, 92604-3309, US

(21) Appl. No.: 11/405,282

(22) Filed: Apr. 17, 2006

(51) Int. Cl. G09B 19/00

(52) U.S. Cl. 434/236

(57) ABSTRACT

This system is a diabetic teaching process, an interactive computer simulator which allows the patient to enter their individual type insulin, diet calorie requirements, and the system calculates, based on variance, accumulative percent calories affecting blood sugar minus accumulative percent insulin released, a series of 4 cases and verify reports. The patient must complete verify and revise process for a 24 hour period to gain the knowledge necessary to help control diabetes.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

This teaching process is designed as a supplement to classes on controlling diabetes. The system generates reports by calculating the accumulative percent calories affecting blood sugar minus accumulative percent insulin released, in 15 minute into for a 24 hour period The current classes on diabetes consists of diet control menu planning and fast food choices, and do not teach the individual patient the process necessary to control diabetes.

### BRIEF SUMMARY OF THE INVENTION

The computer simulator is a diabetic teaching process, designed to help teach the diabetic patient how to determine the individual patient point of equilibrium, the point of insulin requirement and calorie intake which result in stable blood sugar. It is an interactive process, patient input and computer calculations, with the computer generating insulin and meal reports for the individual patient. The patient must complete the verification and revise process to gain the knowledge necessary to help control the individual patient diabetes.

### BRIEF DESCRIPTION OF THE SEVERAL VIEWS OF THE DRAWING

“Not Applicable”

### DETAILED DESCRIPTION OF THE INVENTION

Patient Interface Flowchart

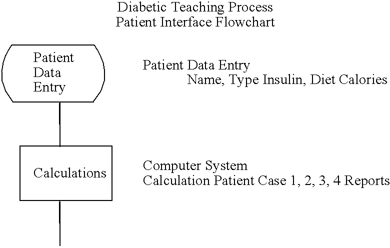

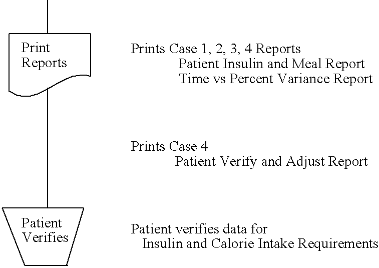

Patient Information Form

The patient double clicks on the icon, or enters the internet identity given by the instructor, to access the computer screen for data entry.
a. Type in the patient name to appear on reports
b. Select Type Insulin
c. Select Diet Calories
d. Select all 4 cases to print
e. Press Continue
f. The system will print 4 cases, patient verify and revise report, all based on the individual patient Type Insulin and Calories selected

Case 1, Patient Insulin and Meal Report, Additional Extra snack, exceeding 3 main meals with an additional snack does not properly maintain diabetes. Time vs Pct Variance Report show the projected result of exceeding diet calories, with a large variance. The system plots the calculated values, in 30 minutes intervals, on a time vs percent varance graph. The average blood sugar, by Points, is calculated by summing the percent variance over the 24 hours, and multiplying by Points. The HbA1C is calculated from the average blood sugar. Average blood sugar calculated for case 1 does not reflect the reduction in blood sugar due to spillover of sugar in urine.

Case 2, Patient Insulin and Meals Report, 3 main meals, shows the projected results of eating 3 main meals, though remaining on the individual patient diet, does not properly maintain diabetes. Time vs Pct Variance Report, average blood sugar calculated for case 2 does not reflect the reduction in blood sugar due to spillover of sugar in the urine.

Case 3, Patient Insulin and Meals Report, Fast food, shows the projected results of eating fast food for lunch and a salad for dimmer, though remaining on the individual patient diet, does not properly maintain diabetes. Time vs Pct Variance Report, average blood sugar calculated for case 3 does not reflect the reduction in blood sugar due to spillover of sugar in the urine.

Case 4, Patient Insulin and Meals Rot, Controlled Diabetic, the calorie intake has been arranged so that percent calories released equals percent insulin released, and must be verified, and adjusted, by completing a 24 hour verification process. Time vs Pct Varance Report case 4, Controlled Diabetic, spillover of sugar in the urine does not occur due to controlled blood sugar. All 4 cases use the same base calories selected by the patient, yet the HbA1C will vary fan greater than 10, extra calories, down to 6.0, a controlled diabetic. The difference is in the knowledge of how to control diabetes.

Patient Verify and Adjust Report The patient selects the number of insulin units necessary to maintain the individual point of equilibrium The verification report outlines the Time and Type of Insulin, Time and Number of each type calories, and a space to complete the tested blood sugar before each meal. The calorie intake should be adjusted during the 24 hour period to maintain a stable blood sugar between 100 and 130. The actual calorie intake must be completed, and any variance noted in the Us column If adjustments are made to the Insulin Requirements, or the calorie intake, then the verification process should be completed for the next 24 hour period, or until patient is satisfied with the level of control. The patient now has a record of the requirements necessary to help maintain diabetes.

Detail Design Flowchart. The Detail Design Flowchart reviews each of
the detail calculation steps necessary to support the system.

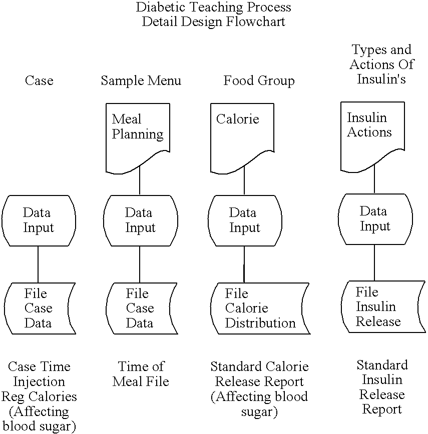

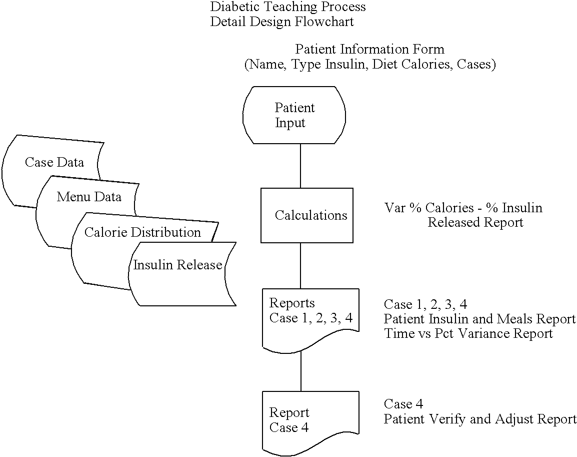

Basic System Logic

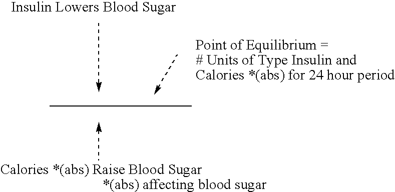

Basic logic, Calories raise Blood sugar and Insulin lowers blood sugar. There exists for each patient a point of equilibrium, at which, if the affect of calories released that raise blood sugar, and the affect of insulin released that lowers blood sugar are equal, then the blood sugar will remain stable for the individual patient This system helps to educate the patient in the steps necessary to determine their individual point of equilibrium. The system compares for each 15 minute interval, the percent of calories released which affect blood sugar, and the percent of insulin released, for a 24 hour period. The difference between accumulative percent calories released, which affect blood sugar, and accumulative percent insulin released, is defined as the percent vanance, a value that can be calculated and placed on a graph If the percent variance is zero, and the number of insulin units is correct for the individual patient, then the point of equilibrium is maintained.

Meal Plans 1200, 1500, 1800, 2000, 2200, 2400. The system is designed as a supplement to current classes on diet control, and utilizes the same meal plans. The 1800 calorie meal plan is the basis for case studies, with the additional snack values based on Fast food values. The 2000 meal plan is the basis for the expanded 2200 and 2400 meal plans.

Food Group. Percent Calories is determined from nutrition booklets utilized in diet classes. Calories released (selected distribution) 15 minute intervals
Milk 90 calories over 2 hours at 100% (abs)
Starch 80 calories over 2 hours at 100% (abs)
Meat 60 calories (20 fat), 40 calories over 4 hours at 50% (abs)
Fruit 60 calories over ½ hour at 100% (abs)
Vegetable 25 calories over 2 hours at 100% (abs)
Fat 45 calories at 0%, not considered affecting blood sugar

Standard Calorie Release Report. Calories are released on a selected distribution curve, with 15 minute intervals, and actual distribution may vary for the individual patient, the verification process is used to adjust the actual calorie requirements.

Insulin Actions, Standard Insulin Release Report The system utilizes the Insulin Action release charts provided by the insulin manufacturer. The percent insulin released is determined by type insulin, for each 15 minute interval, by superimposing the release curve on graph paper, and counting the number of squares under the curve, divided by the total number of squares under the total curve, expressed as a percent The Long-Acting U has a 24 hour carry over percent, and requires the same injection time each day. Intermediate Acting, Long Acting, and Premixed Insulin types are limited to 1 injection per 24 hour period.

Multiple injections in a 24 hour period require a proportion value be used for the insulin release for type Rapid Acting, and Short Acting Regular. The None insulin selection uses an even distribution of insulin by the patients own insulin producing capabilities, placing a cap on the amount of percent insulin released at 1.59 percent, for each 15 minute interval, with a maximum of 100%.

The system simulation calculations, Varance is calculated for each 15 minute interval,

Variance=Sum (% Calories abs) minus Sum (% Insulin Released)
Points=Tested (Blood Sugar 1 minus Blood Sugar 2) divide by % Insulin Released
Points (in blood sugar per 1 percent variance) may be calculated for a patient by the change in blood sugar for a 1 hour period when Calories are not released, and blood sugar is less than 135, divided by the % Insulin released in the same time period.

Average Blood Sugar=Average (Variance multiply by Points plus 115)

HbA1C=(Average Blood Sugar minus 90) divide by 30 plus 5

Calculated Affect on Blood Sugar

1 Starch=80 divide Total Calories affecting blood sugar multiply 100 multiply Points

1 Fruit=60 divide Total Calories affecting blood sugar multiply 100 multiply Points

Calculated Affect Expressed as a Percent

1 Starch as %=80 divide by Total Calories affecting blood sugar multiply 100

1 Fruit as %=60 divide by Total Calories affecting blood sugar multiply 100

Case 4, Var % Calories minus % Insulin Released Report The system completes a series of data accumulation and calculations to develop the information and graphs for the reports. The distributed calories are associated to the meal plan and case number selected. The accumulative percent Type Insulin distribution over the 24 hour time frame, in 15 minute intervals, are associated to the insulin injection time, meal plan, and case number selected The system accumulates the calories released, determines percent calories released, accumulates percent insulin released, and calculates variance for each 15 minute interval.

I claim:

1. A computer simulation process to teach the individual patient the knowledge necessary to help control diabetes:

2. The process of claim 1 wherein patient inputs minimal amount of data selection type insulin and diet calories category.

3. The process of claim 2 wherein the computer system calculations, percent variance equals accumulative percent calories affecting blood sugar minus accumulative percent insulin released for each 15 minute interval for a 24 hour period, are based on the individual patient selection of type insulin and diet calories category.

4. The process of claim 3 wherein the computer generates case 1, example exceeds diet calories, and prints reports showing meal plan, graph of variance for each 30 minute interval for a 24 hour period, average blood sugar and HbA1C for a range of points.

5. The process of claim 3 wherein the computer generates case 2, example 3 main meals, and prints reports showing meal plan, graph of variance for each 30 minute interval for a 24 hour period, average blood sugar and HbA1C for a range of point.

6. The process of claim 3 wherein the computer generates case 3, example fast food, and prints reports showing meal plan, graph of variance for each 30 minute interval for a 24 hour period, average blood sugar and HbA1C for a range of points.

7. The process of claim 3 wherein the computer generates case 4, example controlled diabetic, and prints reports showing meal plan, graph of variance for each 30 minute interval for a 24 hour period, average blood sugar and HbA1C for a range of points, and verify and revise report.

8. The process of claim 1 wherein the patient determines the points, the change in tested blood sugar for a given period of time when calories are not being released and blood sugar is below 135, divided by the percent insulin released in the same time period.

9. The process of claim 1 wherein the patient follows the meal plan in verify and revise report for a 24 hour period, tests blood sugar before each meal, and corrects the calorie intake if the blood sugar is not within acceptable limits.

10. The process of claim 9 wherein the patient follows the revised meal plan in verify and revise report for a 24 hour period, and corrects the calorie intake or amount of insulin required, until the patient is satisfied with the level of blood sugar control.
